(19) United States
(12) Patent Application Publication
(10) Pub. No.: US 2025/0180876 A1
(43) Pub. Date: Jun. 5, 2025

(54) OPTICAL SYSTEM

(71) Applicant: TDK TAIWAN CORP., Taoyuan City (TW)

(72) Inventors: Chia-Che WU, Taoyuan City (TW); Yi-Ho CHEN, Taoyuan City (TW)

(21) Appl. No.: 18/964,077

(22) Filed: Nov. 29, 2024

Related U.S. Application Data
(60) Provisional application No. 63/604,459, filed on Nov. 30, 2023.

(51) Int. Cl. G02B 13/00; G02B 5/00; G02B 7/09; G02B 7/18; G02B 7/28; H04N 23/54

(52) U.S. Cl. CPC G02B 13/0065; G02B 5/005; G02B 7/09; G02B 7/1805; G02B 7/28; H04N 23/54

(57) ABSTRACT

An optical system is provided, including an aperture module and an optical module. The optical module is connected to the aperture module along a vertical direction. The aperture module has a housing, an aperture mechanism, and an optical element. The aperture mechanism and the optical element are disposed in the housing. Light propagates through the aperture mechanism and the optical element of the aperture module to the optical module in the vertical direction.

### CROSS REFERENCE TO RELATED APPLICATIONS

This application claims the benefit of U.S. Provisional Application No. 63/604,459, filed Nov. 30, 2023, the entirety of which is incorporated by reference herein.

### BACKGROUND OF THE INVENTION

### Field of the Invention

The present invention relates to an optical system, and, in particular, to an optical system that has an aperture mechanism.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and magnets corresponding thereto are usually used for adjusting the focus of a lens. However, miniaturization of these electronic devices may increase the difficulty of mechanical design, and it may also lead to low reliability and low driving force for moving the lens. Therefore, addressing the aforementioned problems has become a challenge.

### BRIEF SUMMARY OF THE INVENTION

An embodiment of the present invention provides an optical system that includes an aperture module and an optical module. The optical module is connected to the aperture module along a vertical direction. The aperture module has a housing, an aperture mechanism, and an optical element. The aperture mechanism and the optical element are disposed in the housing. Light propagates through the aperture mechanism and the optical element of the aperture module to the optical module in the vertical direction.

In some embodiments, the optical module has a prism, a fixed part and a movable part, the movable part is movably received in the fixed part, and the prism is disposed on the movable part for reflecting the external light.

### BRIEF DESCRIPTION OF THE DRAWINGS

The present invention can be more fully understood by reading the subsequent detailed description and examples with references made to the accompanying drawings, wherein:

FIG. 1 shows a perspective diagram of an optical system 100 in accordance with an embodiment of the invention.

FIG. 2 shows another perspective diagram of the optical system 100 in FIG. 1.

FIG. 3 shows an exploded diagram of an optical system 100 in FIGS. 1-2.

FIG. 4 shows another exploded diagram of the optical system 100 with the housings H1 and H2 removed therefrom.

FIG. 5 shows an exploded diagram of the optical module 30 in FIGS. 1-4.

FIG. 6 shows a cross-sectional view of the optical system 100 in FIGS. 1-2.

FIG. 7 shows a partial enlarged view of the optical system 100 in FIG. 6.

FIG. 8 shows a side view of the optical system 100 in FIGS. 1-2.

FIG. 9 shows a partial cross-sectional view of an optical system 200 in accordance with another embodiment of the invention.

FIG. 10 shows a partial cross-sectional view of an optical system 300 in accordance with another embodiment of the invention.

### DETAILED DESCRIPTION OF THE INVENTION

The making and using of the embodiments of the optical system are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

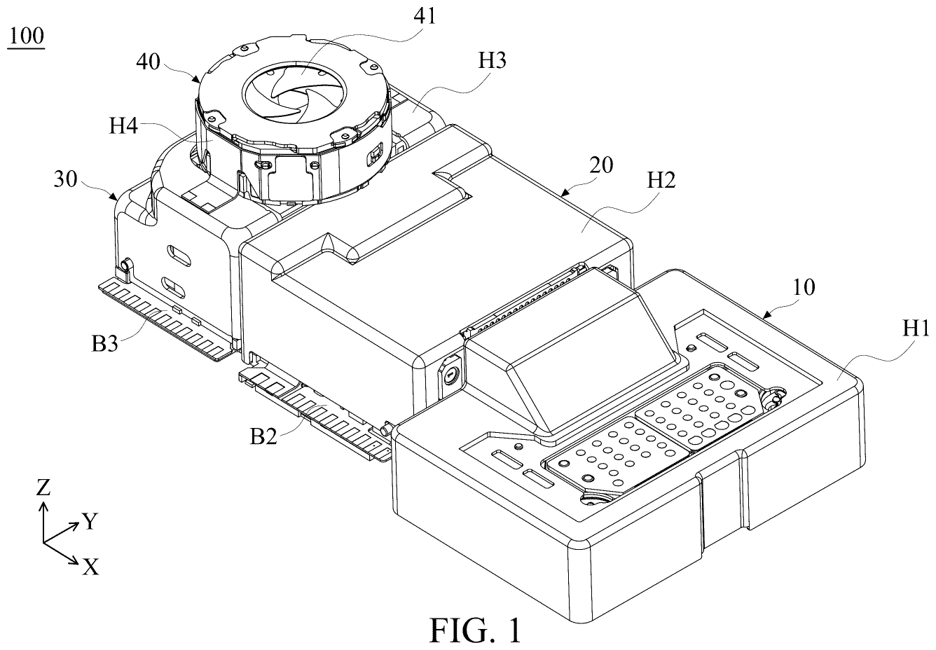

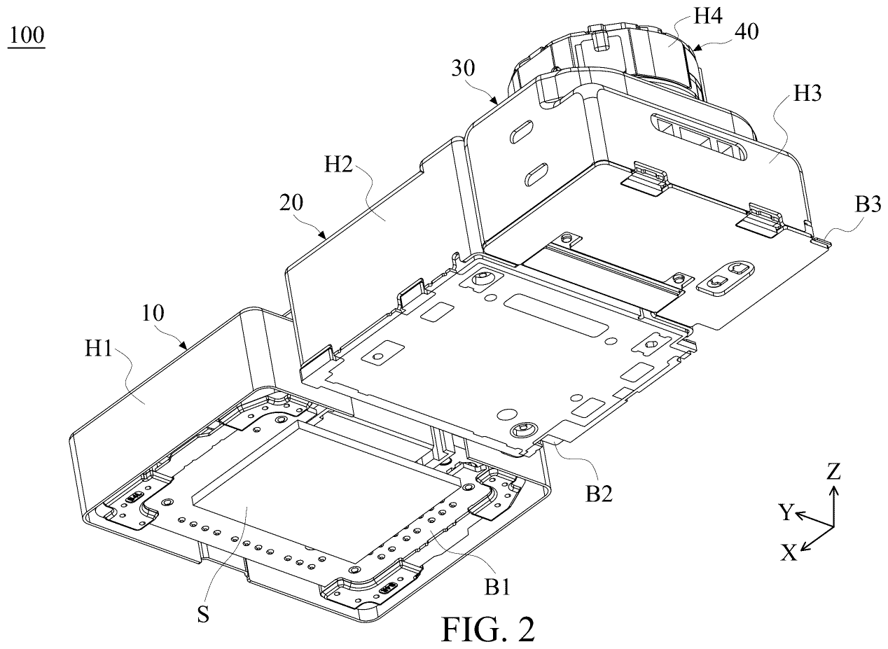

FIG. 1 shows a perspective diagram of an optical system 100 in accordance with an embodiment of the invention. FIG. 2 shows another perspective diagram of the optical system 100 in FIG. 1.

Referring to FIGS. 1-2, the optical system 100 in this embodiment may be disposed in a cell phone or other portable electronic device. Specifically, the optical system 100 may comprise at least one Voice Coil Motor (VCM) for moving at least one optical element (e.g. optical lens or prism), thus achieving the function of Auto Focusing (AF) and/or Optical Image Stabilization (OIS).

The optical system 100 primarily comprises an image sensing module 10, a lens module 20, an optical module 30, and an aperture module 40. The lens module 20 is connected between the optical module 30 and the image sensing module 10 along the X axis, and the optical module 30 is connected to the aperture module 40 along the Z axis, whereby the optical system 100 has an L-shaped structure.

It should be noted that several optical elements (e.g. optical lenses or prisms) are disposed in the housings H1, H2, and H3 of the image sensing module 10, the lens module 20, and the optical module 30. Additionally, an aperture mechanism 41 is disposed in the housing H4 of the aperture module 40. External light can enter the aperture module 40 in the -Z direction, and it can be reflected by the prism inside the optical module 30 and then propagate through the lens module 20 in the X direction to the image sensing module 10. Subsequently, light can be reflected by another prism in the image sensing module 10 and reach the image sensor S at the bottom of the image sensing module 10 to form a digital image.

Still referring to FIGS. 1-2, a circuit board B1 is disposed on the bottom side of the image sensing module 10, wherein the image sensor S is connected to the circuit board B1. Moreover, a circuit board B2 is disposed on the bottom side of the lens module 20, and another circuit board B3 is disposed on the bottom side of optical module 30, wherein the circuit boards B2 and B3 are aligned to each other.

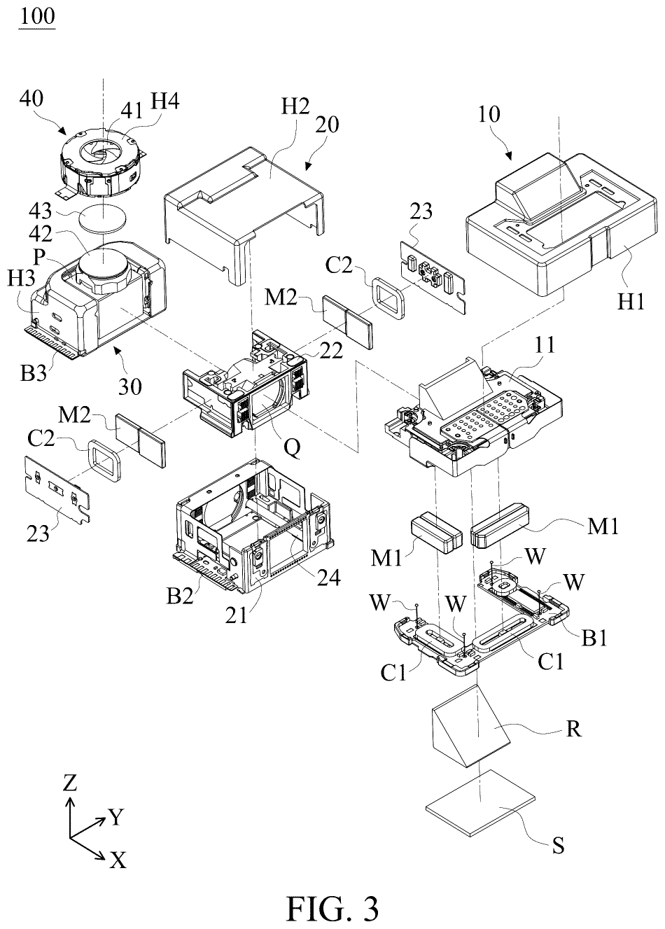

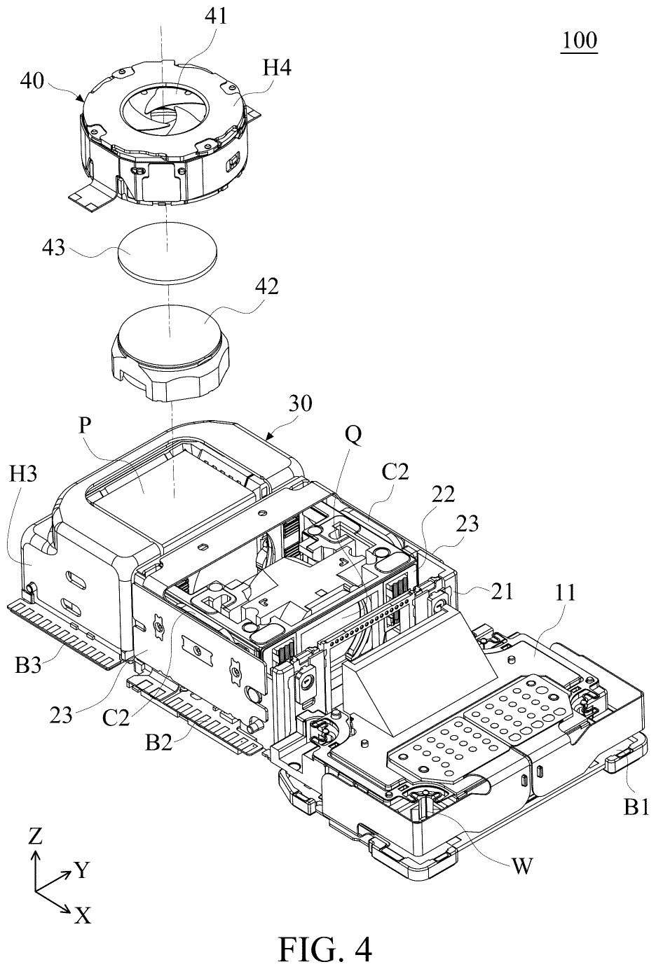

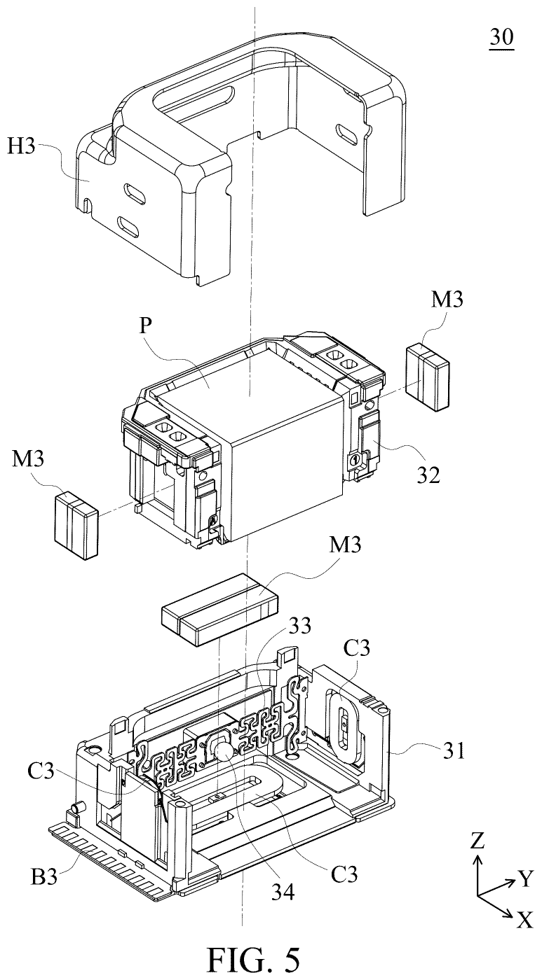

FIG. 3 shows an exploded diagram of an optical system 100 in FIGS. 1-2. FIG. 4 shows another exploded diagram of the optical system 100 with the housings H1 and H2 removed therefrom. FIG. 5 shows an exploded diagram of the optical module 30 in FIGS. 1-4.

Referring to FIGS. 3-4, the image sensing module 10 primarily comprises a housing H1, a frame 11, at least a magnetic element M1, at least a coil C1, several resilient members W (e.g. thin metal wires), a circuit board B1, a reflecting element R, and an image sensor S. The housing H1 and the frame 11 are mounted to each other and constitute a fixed part of the image sensing module 10. The magnetic elements M1 and the coils C1 constitute a driving assembly of the image sensing module 10 for driving the circuit board B1 and the image sensor S to move relative to the housing H1 and the frame 11.

In this embodiment, the reflecting element R is affixed in the frame 11, and the resilient members W are connected between the circuit board B1 and the frame 11. Here, the magnetic elements M1 are disposed at the bottom of the frame 11, and the coils C1 are disposed on the circuit board B1 and electrically connected to the circuit board B1.

In this configuration, a current signal generated from an external circuit can be applied through the circuit board B1 to the coils C1, and an electromagnetic force can be produced by the coils C1 and the magnetic elements M1. Therefore, the circuit board B1 and the image sensor S can be driven to move relative to the frame 11 and the housing H1 along the X axis or the Y axis, whereby the function of Optical Image Stabilization (OIS) can be achieved.

The lens module 20 primarily comprises a housing H2, a base 21, a holder 22, at least a substrate 23, at least a rod 24, at least a magnetic element M2, at least a coil C2, a circuit board B2, and an optical lens Q. The housing H2 and the base 21 are mounted to each other and constitute a fixed part of the lens module 20. The magnetic elements M2 and the coils C2 constitute a driving assembly of the lens module 20 for driving the holder 22 to move relative to the housing H2 and the base 21.

It should be noted that the optical lens Q is affixed in the holder 22, and the circuit board B2 is disposed at the bottom of the base 21. The rod 24 is affixed in the base 21, and the holder 22 is movably disposed on the rod 24, whereby the holder 22 and the optical lens Q can move relative to the base 21 along the X axis.

In this embodiment, the magnetic elements M2 are disposed on opposite sides on the base 21. The substrates 23 are mounted on the inner sides of the housing H2 and electrically connected to the circuit board B2. The coils C2 are disposed on the substrates 23 and face the magnetic elements M2.

In this configuration, a current signal generated from an external circuit can be applied through the circuit board B2 to the coils C2, and an electromagnetic force can be produced by the coils C2 and the magnetic elements M2. Therefore, the holder 22 and the optical lens Q can be driven to move relative to the base 21 along the X axis, whereby the function of Auto Focusing (AF) and/or Optical Image Stabilization (OIS) of the optical system 100 can be achieved.

As shown in FIG. 5, the optical module 30 primarily comprises a housing H3, a base 31, a movable part 32, at least a spring sheet 33, a hinge member 34, at least a magnetic element M3, at least a coil C3, a circuit board B3, and a prism P. The magnetic elements M3 and the coils C3 constitute a driving assembly of the optical module 30 for driving the movable part 32 to move relative to the housing H3 and the base 31.

The housing H3 and the base 31 are mounted to each other and constitute a fixed part of the optical module 30. The movable part 32 is movably received in the base 31, and the prism P is disposed on the movable part 32. The hinge member 34 may comprise a ball joint pivotally connecting the movable part 32 to the base 31. Moreover, the spring sheet 33 is connected between the movable part 32 and the base 31.

It should be noted that the magnetic elements M3 are disposed on the movable part 32, and the coils C3 are disposed on the base 31 and electrically connected to the circuit board B3. In this configuration, a current signal generated from an external circuit can be applied through the circuit board B3 to the coils C3, and an electromagnetic force can be produced by the coils C3 and the magnetic elements M3. Therefore, the movable part 32 and the prism P can be driven to rotate relative to the base 31, whereby the function of Optical Image Stabilization (OIS) can be achieved.

The aperture module 40 in FIGS. 3-4 primarily comprises a housing H4, an aperture mechanism 41, an optical element 42, and a lens 43. The aperture mechanism 41, the optical element 42, and the lens 43 are received in the housing H4, and the housing H4 is affixed to the top surface of the housing H3 of the optical module 30. For example, the optical element 42 may comprise an optical lens, and the lens 43 may comprise a transparent flat lens or a lens filter.

In this embodiment, the lens 43 is situated between the aperture mechanism 41 and the optical element 42 along the Z axis. In some embodiments, however, the lens 43 may be omitted from the aperture module 40, and the present invention is not limited to the embodiments.

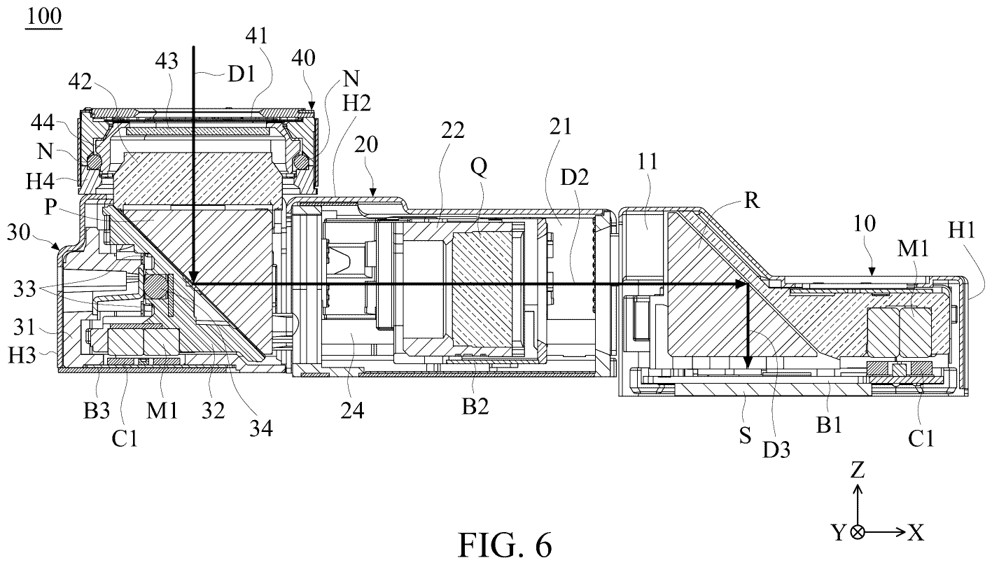

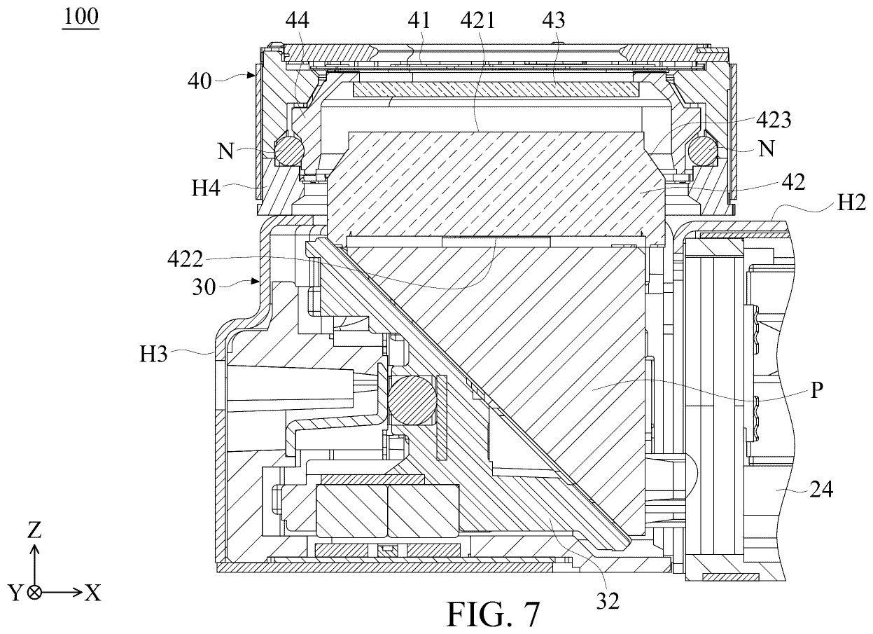

FIG. 6 shows a cross-sectional view of the optical system 100 in FIGS. 1-2. FIG. 7 shows a partial enlarged view of the optical system 100 in FIG. 6.

Referring to FIGS. 6-7, the aperture mechanism 41 and the lens 43 are affixed to a holder 44 that is movably received in the housing H4. The holder 44 is pivotally connected to the housing H4 via a hinge member N (e.g. ball joint). During assembly of the optical system 100, the optical element 42 can be adhered to the top surface of the movable part 32 or the prism P. Here, the optical element 42 is spaced apart from the housing H4, the aperture mechanism 41, the lens 43, and the holder 44.

In this embodiment, the optical element 42 and the lens 43 are located between the aperture mechanism 41 and the prism P, wherein the lens 43 is located between the aperture mechanism 41 and the optical element 42.

The holder 44 is pivotally connected to the housing H4 via a hinge member N. In some embodiments. In some embodiments, however, the holder 44 may be affixed to the housing H4,, and the present invention is not limited to the embodiments.

External light can propagate sequentially through the aperture mechanism 41, the lens 43, and the optical element 42 of the aperture module 40 to the prism P of the optical module 30 along the -Z direction, as the vertical direction D1 indicates in FIG. 6. Subsequently, light can be reflected by the prism P and propagate through the optical lens Q of lens module 20 to the reflecting element R (e.g. prism) of the image sensing module 10 along the X direction, as the horizontal direction D2 indicates in FIG. 6. Light is then reflected by the reflecting element R and reaches the image sensor S at the bottom of the image sensing module 10 to form a digital image, as the vertical direction D3 indicates in FIG. 6, wherein the vertical directions D1 and D3 are parallel to each other and perpendicular to the horizontal direction D2.

It can be seen in FIG. 7 that the optical element 42 protrudes from the bottom side of the aperture module 40 and extends through the housing H3 into the optical module 30. When viewed along the X axis or the Y axis, the optical element 42 partially overlaps the optical module 30 and the aperture module 40. Specifically, the optical element 42 has a top portion 421 and a bottom portion 422 facing the prism P. During assembly, the bottom portion 422 is affixed to the top surface of the movable part 32 or the prism P by adhesive. Thus, the optical element 42 can be moved along with the prism P, thereby improving the performance of Optical Image Stabilization (OIS).

In this embodiment, the width of the top portion 421 is smaller than the width of the bottom portion 422. Additionally, the optical element 42 forms an annular recess 423 that is located adjacent to the top portion 421. Hence, the optical element 42 can be prevented from being impacted by the housing H4 or the holder 44 when rotating along with the prism P.

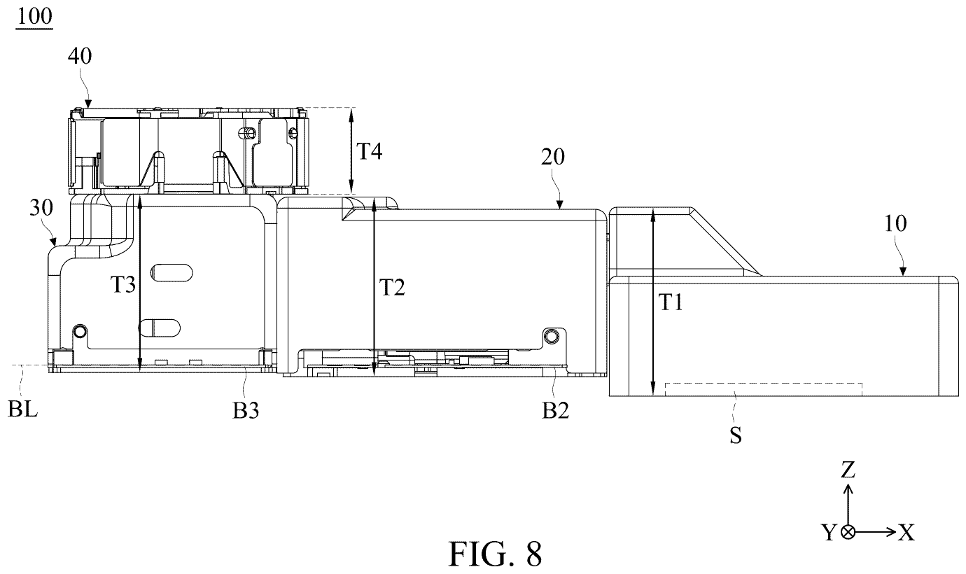

FIG. 8 shows a side view of the optical system 100 in FIGS. 1-2. Referring to FIGS. 1 and 8, a plurality of conductive pads are provided on the top surfaces of the circuit boards B2 and B3 of the lens module 20 and the optical module 30. Specifically, the top surfaces of the two circuit boards B2 and B3 are on the same plane BL that is perpendicular to the Z axis (FIG. 8). Furthermore, the position of the image sensor S is lower than the plane BL along the Z axis.

In this embodiment, the thickness T1 of the image sensing module 10 is greater than the thickness T2 of the lens module 20 along the Z axis, the thickness T2 of the lens module 20 is greater than the thickness T3 of the optical module 30 along the Z axis, and the thickness T3 of the optical module 30 is greater than the thickness T4 of the aperture module 40 along the Z axis.

It should be noted that the bottom surface of the housing H4 of the aperture module 40 is affixed to the top surface of the housing H3 of the optical module 30. The top surface of the optical module 30 is higher than the top surface of the lens module 20, and the lens module 20 is spaced apart from the aperture module 40. As shown in FIG. 8, since the aperture module 40 is situated higher than the lens module 20, the optical module 30, and the aperture module 40, the optical system 100 has an L-shaped structure.

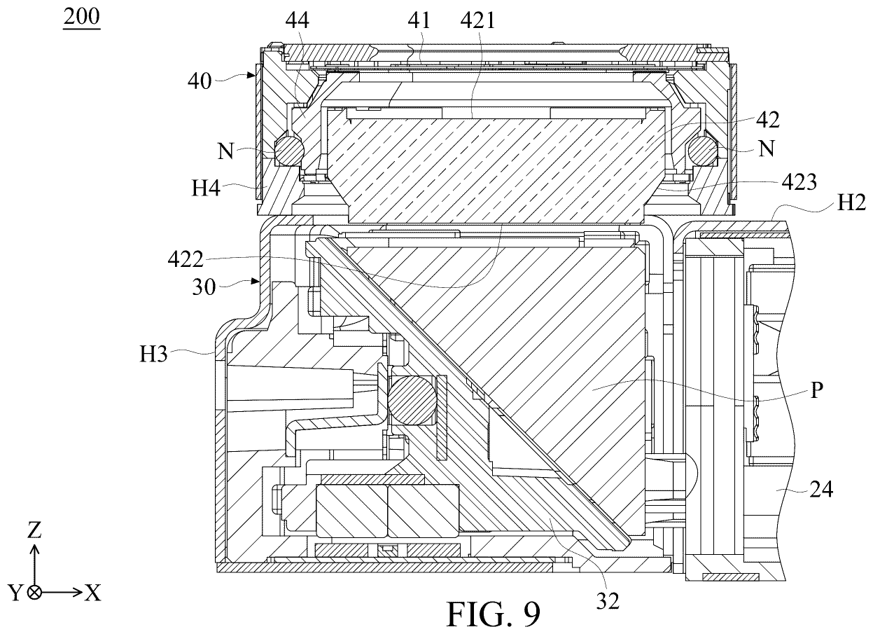

FIG. 9 shows a partial cross-sectional view of an optical system 200 in accordance with another embodiment of the invention. The optical system 200 is different from the optical system 100 of FIG. 7 in that the optical element 42 in FIG. 9 is adhered to the holder 44 of the aperture module 40 and spaced apart from the prism P.

In this embodiment, a part of the optical element 42 extends into the optical module 30. When viewed along the X axis or the Y axis, the optical element 42 partially overlaps the optical module 30 and the aperture module 40. Additionally, the width of the top portion 421 is greater than the width of the bottom portion 422, wherein an annular recess 423 is formed on the optical element 42 and located adjacent to the bottom portion 422. Hence, the optical element 42 can be prevented from being impacted by the housing H3 of the optical module 30.

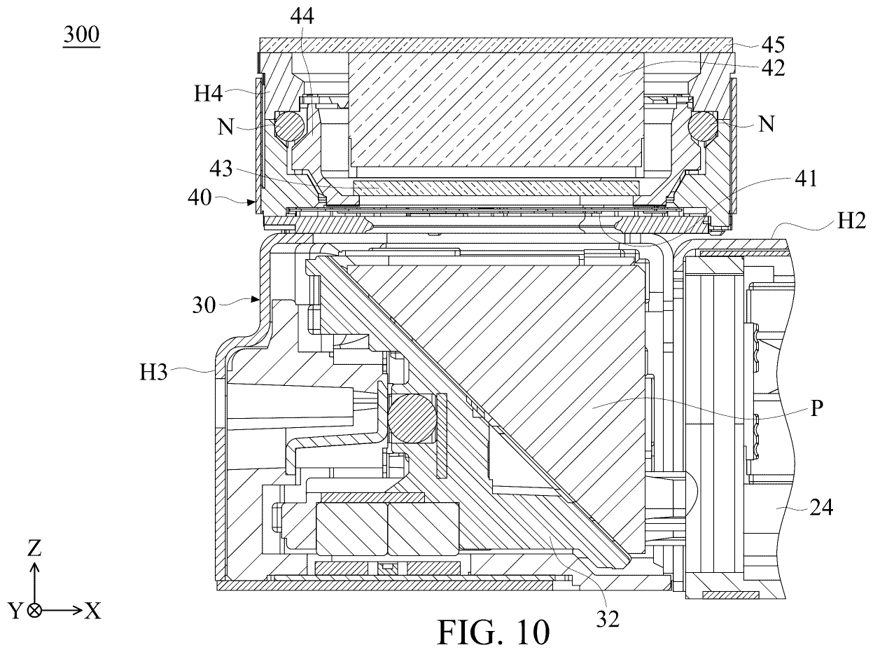

FIG. 10 shows a partial cross-sectional view of an optical system 300 in accordance with another embodiment of the invention. The optical system 300 is different from the optical system 100 of FIG. 7 in that the optical element 42 in FIG. 10 is connected to a top cover 45 of the aperture module 40.

As shown in FIG. 10, the top cover 45 comprises transparent material and is affixed to the top side of the housing H4. In this embodiment, the aperture mechanism 41 and the lens 43 are adhere to the holder 44, and the optical element 42 does not extend into the optical module 30. Hence, when viewed along the X axis or the Y axis, the optical element 42 partially overlaps the aperture module 40, but does not overlap the optical module 30, wherein the aperture mechanism 41 and the lens 43 are situated between the optical element 42 and the prism P along the Z axis.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical system, comprising:
an aperture module, having a housing, an aperture mechanism, and an optical element, wherein the aperture mechanism and the optical element are disposed in the housing; and
an optical module, connected to the aperture module along a vertical direction, wherein an external light propagates through the aperture mechanism and the optical element along the vertical direction to the optical module.

2. The optical system as claimed in claim 1, wherein the optical module has a prism, a fixed part and a movable part, the movable part is movably received in the fixed part, and the prism is disposed on the movable part for reflecting the external light.

3. The optical system as claimed in claim 2, wherein a part of the optical element extends into the optical module.

4. The optical system as claimed in claim 3, wherein the optical element is affixed to the prism.

5. The optical system as claimed in claim 3, wherein the optical element is affixed to the movable part.

6. The optical system as claimed in claim 3, wherein the optical element has a top portion and a bottom portion, the bottom portion faces the prism, and the width of the top portion is smaller than the width of the bottom portion.

7. The optical system as claimed in claim 6, wherein the optical element further has a recess adjacent to the top portion.

8. The optical system as claimed in claim 3, wherein the optical element has a top portion and a bottom portion, the bottom portion faces the prism, and the width of the top portion is greater than the width of the bottom portion.

9. The optical system as claimed in claim 8, wherein the optical element further has a recess adjacent to the bottom portion.

10. The optical system as claimed in claim 3, wherein the optical element is spaced apart from the aperture mechanism along the vertical direction.

11. The optical system as claimed in claim 3, wherein the optical element is located between the aperture mechanism and the prism along the vertical direction.

12. The optical system as claimed in claim 3, wherein the optical module further has a lens disposed in the housing and located between the aperture mechanism and the optical element.

13. The optical system as claimed in claim 2, wherein the optical module further has a driving assembly disposed on the fixed part and the movable part, and an electromagnetic force is generated by the driving assembly to rotate the movable part relative to the fixed part.

14. The optical system as claimed in claim 2, wherein the aperture mechanism is located between the optical element and the prism.

15. The optical system as claimed in claim 1, further comprising a lens module and an image sensing module, wherein the lens module is connected between the optical module and the image sensing module along a horizontal direction, the optical module has a prism, and the lens module has an optical lens, wherein the external light is reflected by the prism and propagates through the optical lens to the image sensing module.

16. The optical system as claimed in claim 15, wherein the image sensing module has a reflecting element and an image sensor, and the external light is reflected by the reflecting element to the image sensor to generate a digital image.

17. The optical system as claimed in claim 16, wherein the lens module and the optical module respectively have a circuit board, the top surfaces of the circuit boards are situated on the same plane that is perpendicular to the vertical direction.

18. The optical system as claimed in claim 17, wherein the position of the image sensor is offset from the plane along the vertical direction.

19. The optical system as claimed in claim 16, wherein the thickness of the image sensing module is greater than the thicknesses of the lens module and the optical module along the vertical direction.

20. The optical system as claimed in claim 16, wherein the thickness of the lens module is greater than the thickness of the optical module along the vertical direction.
